(19) United States
(12) Patent Application Publication
(10) Pub. No.: US 2024/0005655 A1
(43) Pub. Date: Jan. 4, 2024

(54) LEARNING APPARATUS, ESTIMATION APPARATUS, LEARNING METHOD, ESTIMATION METHOD AND PROGRAM

(71) Applicant: NIPPON TELEGRAPH AND TELEPHONE CORPORATION, Tokyo (JP)

(72) Inventors: Mihiro UCHIDA, Tokyo (JP); Jun SHIMAMURA, Tokyo (JP); Shingo ANDO, Tokyo (JP); Takayuki UMEDA, Tokyo (JP)

(21) Appl. No.: 18/247,493

(22) PCT Filed: Oct. 21, 2020
(86) PCT No.: PCT/JP2020/039602

§ 371 Date: Mar. 31, 2023

(51) Int. Cl. G06V 10/98; G06V 10/774; G06V 10/764; G06V 10/82

(52) U.S. Cl. CPC G06V 10/98; G06V 10/774; G06V 10/764; G06V 10/82

(57) ABSTRACT

A learning apparatus includes: a data generation unit that learns generation of data based on a class label signal and a noise signal; an unknown degree estimation unit that learns estimation of a degree to which input data is unknown using a training set and the data generated by the data generation unit; a first class likelihood estimation unit that learns estimation of a first likelihood of each class label for input data using the training set; a second class likelihood estimation unit that learns estimation of a second likelihood of each class label for input data using the training set and the data generated by the data generation unit; a class likelihood correction unit that generates a third likelihood by correcting the first likelihood on the basis of the unknown degree and the second likelihood; and a class label estimation unit that estimates a class label of data related to the third likelihood on the basis of the third likelihood, thereby automatically estimating a cause of an error by a deep model.

### TECHNICAL FIELD

The present invention relates to a learning apparatus, an estimation apparatus, a learning method, an estimation method, and a program.

### BACKGROUND ART

Deep learning models are known to be able to execute tasks with high accuracy. For example, it has been reported that accuracy exceeding that of humans has been achieved in the task of image recognition.

On the other hand, it is known that a deep learning model behaves without intention for unknown data and data learned by applying an erroneous label (label noise). For example, in an image recognition model learning an image recognition task, there is a possibility that a correct class label will not be able to be estimated for an unknown image. In addition, there is a possibility of an image recognition model in which a pig image is mistakenly labeled as “rabbit” and trained estimating that the class label of the pig image is “rabbit.” In practical use, a deep learning model which performs such behavior is not preferable.

### CITATION LIST

### Non Patent Literature

Odena, Augustus, Christopher Olah, and Jonathon Shlens. “Conditional image synthesis with auxiliary classifier gans.” International conference on machine learning. 2017.

### SUMMARY OF INVENTION

### Technical Problem

Therefore, it is necessary to take measures in accordance with the cause of the estimation error. For example, if unknown data is the cause, the unknown data needs to be added to the training set. If the label noise is the cause, the label needs to be corrected.

However, it is difficult for a human to accurately estimate the cause of an error.

The present invention has been made in view of the above points, and an object of the present invention is to be able to automatically estimate the cause of an error by a deep model.

### Solution to Problem

In order to solve the above problem, a learning apparatus includes: a data generation unit that learns generation of data based on a class label signal and a noise signal; an unknown degree estimation unit that learns estimation of a degree to which input data is unknown using a training set and the data generated by the data generation unit; a first class likelihood estimation unit that learns estimation of a first likelihood of each class label for input data using the training set; a second class likelihood estimation unit that learns estimation of a second likelihood of each class label for input data using the training set and the data generated by the data generation unit; a class likelihood correction unit that generates a third likelihood by correcting the first likelihood on the basis of the unknown degree and the second likelihood; and a class label estimation unit that estimates a class label of data related to the third likelihood on the basis of the third likelihood, and the data generation unit learns the generation on the basis of the unknown degree and the class label estimated by the class label estimation unit.

### Advantageous Effects of Invention

It is possible to automatically estimate the cause of an error by a deep model.

### BRIEF DESCRIPTION OF DRAWINGS

FIG. 1 is a diagram for describing an ACGAN.

FIG. 2 is a diagram illustrating a hardware configuration example of a class label estimation apparatus 10 according to an embodiment of the present invention.

FIG. 3 is a diagram illustrating a functional configuration example of a class label estimation apparatus 10 according to a first embodiment.

FIG. 4 is a diagram illustrating performance of detecting label noise according to the first embodiment.

FIG. 5 is a diagram illustrating a functional configuration example of a class label estimation apparatus 10a according to a second embodiment.

FIG. 6 is a diagram for describing a functional configuration example for the case of learning of the class label estimation apparatus 10a according to the second embodiment.

FIG. 7 is a diagram for describing a functional configuration example for the case of inference of the class label estimation apparatus 10a according to the second embodiment.

FIG. 8 is a first diagram for describing performance of detecting label noise according to the second embodiment.

FIG. 9 is a second diagram for describing performance of detecting label noise according to the second embodiment.

FIG. 10 is a first diagram for describing performance of detecting unknown data according to the second embodiment.

FIG. 11 is a second diagram for describing performance of detecting unknown data according to the second embodiment.

### DESCRIPTION OF EMBODIMENTS

In the present embodiment, a model (deep neural network (DNN)) based on an auxiliary classifier generative adversarial network (ACGAN) is disclosed. Therefore, first, the ACGAN will be briefly described.

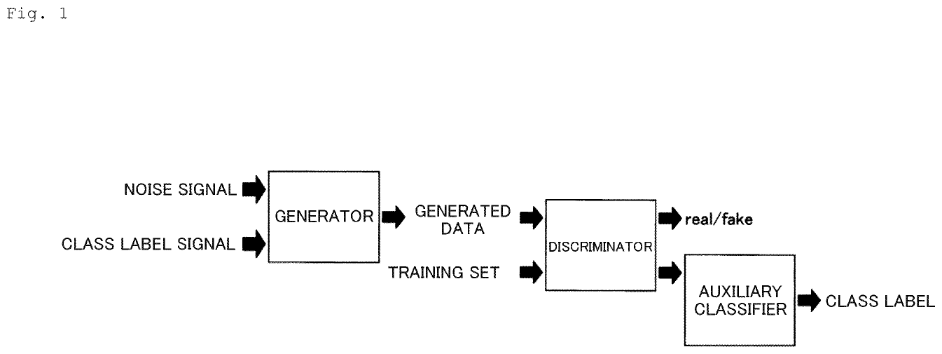

FIG. 1 is a diagram for describing an ACGAN. The ACGAN is a type of conditional GAN (ccGAN), and is a generative adversarial network (GAN) that enables data generation with a designated class label (category label) by attaching an auxiliary classifier to a discriminator in the GAN.

That is, in FIG. 1, the generator generates data (images, etc.) from a noise signal and a class label signal. The noise signal is data that includes the characteristics of the image to be generated. The class label signal is data indicating the class label of the object indicated by the image to be generated. The discriminator discriminates whether or not the data generated by the generator (hereinafter referred to as “generated data”) is actual data included in a training set (that is, whether it is generated data). The auxiliary classifier estimates the class label (hereinafter simply referred to as a “label”) of the data discriminated by the discriminator.

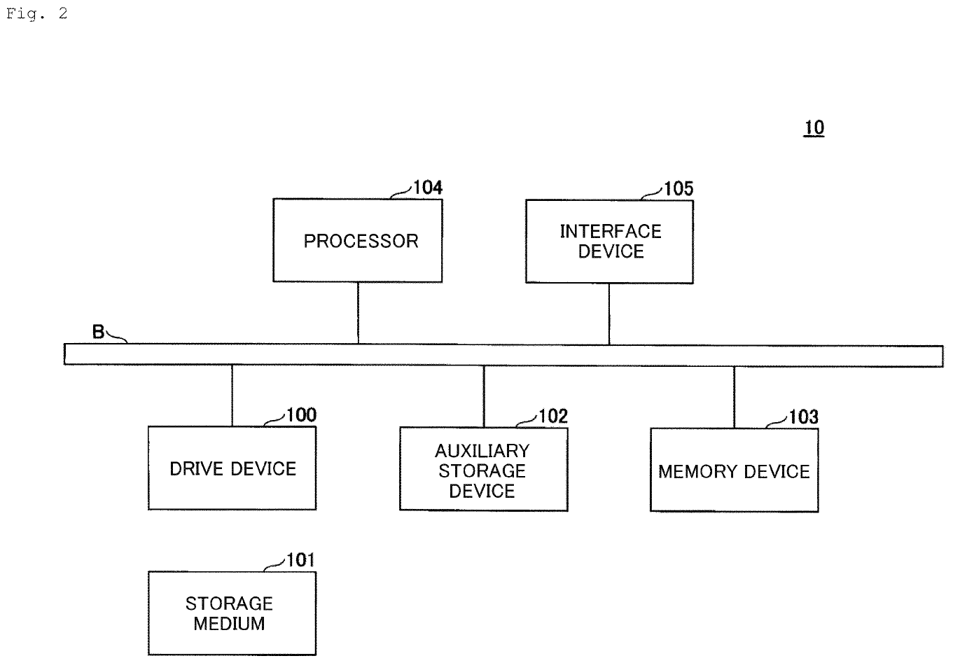

Embodiments of the present invention will be described below with reference to the drawings. FIG. 2 is a diagram illustrating a hardware configuration example of a class label estimation apparatus 10 according to an embodiment of the present invention. The class label estimation apparatus 10 in FIG. 2 includes a drive device 100, an auxiliary storage device 102, a memory device 103, a processor 104, an interface device 105, and the like, which are connected to each other by a bus B.

A program that realizes processing in the class label estimation apparatus 10 is provided by a recording medium 101 such as a CD-ROM. When the recording medium 101 in which the program is stored is set in the drive device 100, the program is installed from the recording medium 101 to the auxiliary storage device 102 through the drive device 100. The program may not necessarily be installed from the recording medium 101 and may be downloaded from another computer via a network. The auxiliary storage device 102 stores the installed program and stores necessary files, data, and the like.

The memory device 103 reads and stores the program from the auxiliary storage device 102 when the program receives an instruction to start. The processor 104 is a CPU or a graphics processing unit (GPU), or a CPU and a GPU, and executes a function related to the class label estimation apparatus 10 according to a program stored in the memory device 103. The interface device 105 is used as an interface for connecting to a network.

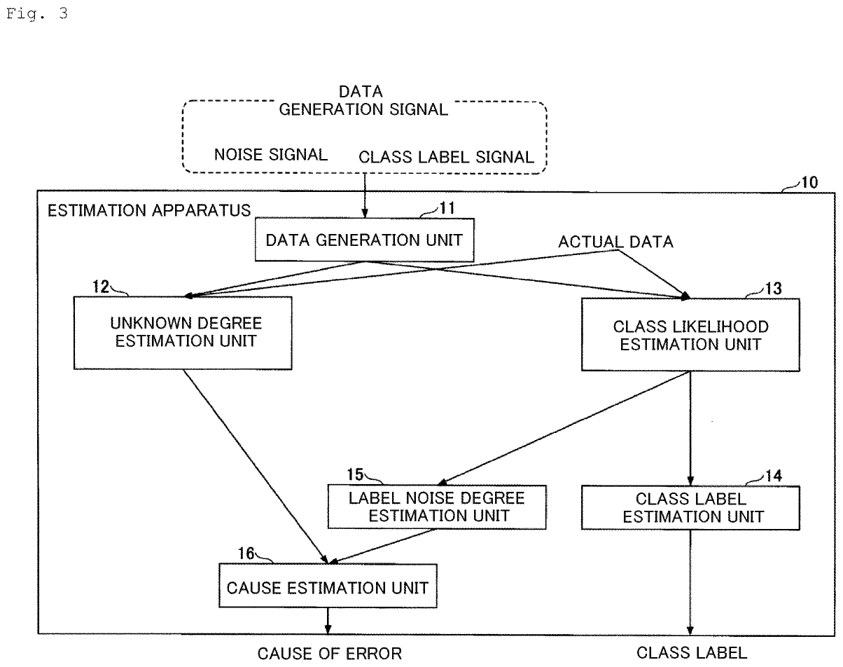

FIG. 3 is a diagram illustrating a functional configuration example of a class label estimation apparatus 10 according to a first embodiment. In FIG. 3, a class label estimation apparatus 10 includes a data generation unit 11, an unknown degree estimation unit 12, a class likelihood estimation unit 13, a class label estimation unit 14, a label noise degree estimation unit 15, a cause estimation unit 16, and the like. Each of these units is realized, for example, by processing executed by the processor 104 by one or more programs installed in the class label estimation apparatus 10. The functional configuration shown in FIG. 3 is based on ACGAN.

The data generation unit 11 is a generator in ACGAN. That is, the data generation unit 11 uses a noise signal and a class label signal as inputs and generates data (for example, image data, etc.) corresponding to the label indicated by the class label signal, which is data similar to actual data (data that actually exists) using the noise signal and the class label signal. At the time of learning, the data generation unit 11 performs learning so that the unknown degree estimation unit 12 estimates the generated data as actual data. The data generation unit 11 is not used at the time of inference (at the time of estimating the class label of the actual data at the time of operation).

The unknown degree estimation unit 12 is a discriminator in ACGAN. That is, the unknown degree estimation unit 12 uses the generated data generated by the data generation unit 11 or the actual data included in the training set as inputs, and outputs an unknown degree related to the input data (a continuous value indicating a degree to which the data is generated data). The unknown degree estimation unit 12 performs threshold processing on the unknown degree. By using the data generated by the data generation unit 11 for learning of the unknown degree estimation unit 12, the unknown degree estimation unit 12 can be trained so that unknown data outside the training set can be explicitly discriminated as unknown.

The class likelihood estimation unit 13 and the class label estimation unit 14 constitute an auxiliary classifier in ACGAN.

The class likelihood estimation unit 13 uses the same input data as the input data to the unknown degree estimation unit 12 as an input, and estimates (calculates) the likelihood of each label for the input data. The likelihood is calculated in a softmax layer in the deep learning model. Therefore, the likelihood of each label is expressed by the softmax vector. The class likelihood estimation unit 13 is trained using both the generated data and the actual data.

The class label estimation unit 14 estimates the label of the input data on the basis of the likelihood of each label estimated by the class likelihood estimation unit 13.

The label noise degree estimation unit 15 and the cause estimation unit 16 are mechanisms added to the ACGAN in the first embodiment in order to estimate the cause of an error in estimation by the ACGAN.

The label noise degree estimation unit 15 estimates a label noise degree which is a degree of influence of label noise (label error in the training set) on the basis of the likelihood of each label estimated by the class likelihood estimation unit 13.

The softmax vector becomes a sharp vector such as [1.00, 0.00, 0.00] in which the likelihood of any one class is overwhelmingly close to 1 when there is no influence of label noise. On the other hand, when there is an influence of label noise, it becomes a flat vector such as [0.33, 0.33, 0.33] in which the likelihoods of all classes have similar values. Therefore, it can be said that the flatness of the softmax vector represents a label noise degree. Therefore, the label noise degree estimation unit 15 outputs, for example, the maximum value of the softmax vector, the difference between the upper two values, the entropy, and the like as the label noise degree.

The cause estimation unit 16 uses the unknown degree estimated by the unknown degree estimation unit 12 and the label noise degree estimated by the label noise degree estimation unit 15 to estimate whether there is a possibility of erroneous recognition because the data to be estimated on the label is unknown, there is a possibility of erroneous recognition due to label noise, or erroneous recognition is not performed because of no problem (that is, the cause of the error). For example, the cause estimation unit 16 determines the output by performing threshold processing for each of the unknown degree and the label noise degree.

A specific example of the threshold processing will be described. On the assumption that it is expected that the unknown degree becomes an index which becomes larger only for the unknown data and the label noise degree becomes an index which becomes larger only for the label noise data, a threshold α for the unknown degree and a threshold β for the label noise degree are set respectively. The cause estimation unit 16 estimates the unknown data as a cause when the unknown degree is higher than the threshold α, and estimates the label noise as a cause when the label noise degree is higher than the threshold β. In addition, when the unknown degree is equal to or less than the threshold α and the label noise degree is equal to or less than the threshold β, the cause estimation unit 16 estimates that there is no problem (about estimation of the label).

As described above, the configuration shown in FIG. 3 includes a mechanism for estimating the cause of an error in estimation by ACGAN.

However, with respect to the above configuration, the inventor of the present application has confirmed that the performance of detecting label noise is low and that unknown data is also determined as label noise.

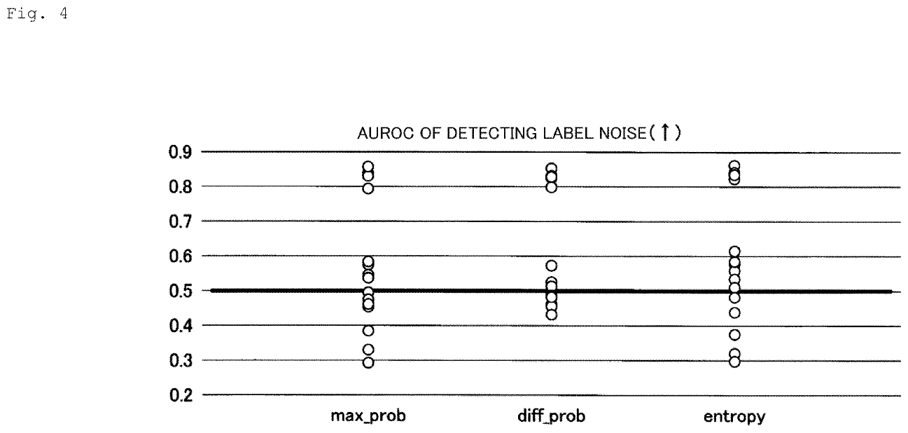

FIG. 4 is a diagram illustrating performance of detecting label noise according to the first embodiment. In FIG. 4, the vertical axis represents an index (AUROC) of performance of detecting the label noise. The AUROC represents that the closer to 1, the better performance is. In addition, in the case of a detector determining by such a guesswork as to be correct at the chance rate, the AUROC is 0.5.

In addition, “max_prob,” “diff_prob,” and “entropy” on the horizontal axis correspond to the case where the maximum value of the softmax vector is the label noise degree, the case where the difference between the upper two values is the label noise degree, and the case where the entropy is the label noise degree in order. Each plot on FIG. 4 shows the performance (AUROC) of detecting label noise for each dataset in these three cases.

According to FIG. 4, in any case of the “max_prob,” “diff_prob,” and “entropy,” the AUROC for many datasets is around 0.5, which does not necessarily mean that good performance is obtained. With this level of performance, high performance cannot be expected for estimation of the cause of error. Therefore, there is a possibility that an appropriate improvement cannot be performed when the operation and maintenance of the deep model shown in FIG. 4 is performed, and that the cost is increased or the defect cannot be corrected efficiently.

A cause of this is considered by the inventor of the present application to be that a flat softmax vector based on unknown data (that is, data generated by the data generation unit 11) is included as an input of the label noise degree estimation unit 15. That is, although label noise is originally a concept defined for known data, in the first embodiment, an evaluation value obtained by integrating known and unknown data is used. Specifically, originally, the softmax vector desired to be acquired as the likelihood of each label is p(y|x, D={training set}), but the softmax vector actually obtained is p(y|x, D={training set, generated data}).

Therefore, next, a second embodiment improved on the basis of the above consideration will be described. Points of difference as to the first embodiment will be described in the second embodiment. Points which are not mentioned particularly in the second embodiment may be similar to those of the first embodiment.

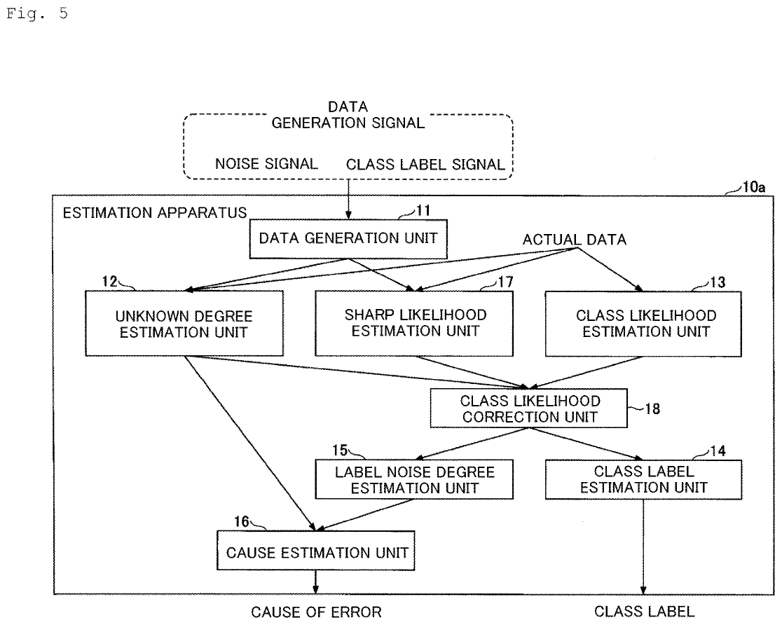

FIG. 5 is a diagram illustrating a functional configuration example of a class label estimation apparatus 10a according to the second embodiment. In FIG. 5 the same or corresponding portions as those in FIG. 3 are designated by the same reference numerals, and the description thereof will be omitted as appropriate.

In FIG. 5, the class label estimation apparatus 10a further includes a sharp likelihood estimation unit 17 and a class likelihood correction unit 18 with respect to the configuration shown in FIG. 3. Further, a change is added to the class likelihood estimation unit 13.

More specifically, in the second embodiment, the class likelihood estimation unit 13 is trained using only the actual data included in the training set.

The sharp likelihood estimation unit 17 estimates (calculates) the likelihood of each label for the input data. The likelihood of each label is calculated in the softmax layer of the deep learning model. The class likelihood estimation unit 13 is trained using both the generated data and the actual data. Regarding the above points, the sharp likelihood estimation unit 17 is the same as the class likelihood estimation unit 13 in the first embodiment. Here, the sharp likelihood estimation unit 17 estimates (outputs) a sharp softmax vector. In order to enable such estimation, the sharp likelihood estimation unit 17 may perform learning so that the softmax vector of the estimation result becomes sharp. As an example of such a learning method, there is a method in which the term of entropy of the softmax vector is used as the constraint term of the loss function. Since the sharp vector and the small entropy have the same meaning, it is expected to estimate the sharp vector by performing learning so that the entropy becomes small.

Alternatively, after performing learning similar to that of the class likelihood estimation unit 13 in the first embodiment, the sharp likelihood estimation unit 17 may perform a conversion so as to sharpen a flat softmax vector among the softmax vectors which are estimation results based on the learning (hereinafter referred to as “initial estimation results”). For example, the conversion so as to sharpen a flat softmax vector may be performed by the following procedures (1) to (3).
(1) A dimension that is the maximum value of the softmax vector of the initial estimation result is specified.
(2) A vector [0, . . . , 0] having the same size as the softmax vector of the initial estimation result is prepared.
(3) Of the vectors prepared in (2), the value of the dimension specified in (1) is changed to 1.

In addition, various methods can be considered for conversion, such as binarizing each dimension of the softmax vector with the maximum value −ε (ε is a small value such as 10⁻⁹) of the softmax vector of the estimation result as a threshold.

The class likelihood correction unit 18 corrects the likelihood estimated by the class likelihood estimation unit 13 on the basis of the unknown degree estimated by the unknown degree estimation unit 12 and the likelihood estimated by the sharp likelihood estimation unit 17. As a correction method, for example, a method of adding weights by unknown degree as in (1) of the following [Math. 1] (that is, a method of using the weighted sum as a correction value) and a method of selecting the likelihood estimated by the class likelihood estimation unit 13 and the likelihood estimated by the sharp likelihood estimation unit 17 according to the condition for the unknown degree as in (2) of the following [Math. 1] can be mentioned. The class likelihood correction unit 18 may correct the likelihood estimated by the class likelihood estimation unit 13 by using a method (algorithm) different between the output to the label noise degree estimation unit 15 and the output to the class label estimation unit 14.

$$\begin{matrix}[ Math . 1 ] & \\ ( 1 - rf ) \times softmax + rf \times {softmax}_{sharp} & ( 1 )\end{matrix}$$

$$\{ \begin{matrix}{softmax}_{sharp} & if rf > th & ( 2 - 1 ) \\ softmax & otherwise & ( 2 - 2 )\end{matrix} \qquad ( 2 )$$

Here, rf is an unknown degree. softmax is an output (softmax vector) from the class likelihood estimation unit 13. softmaxₛₕₐᵣₚ is an output (softmax vector) from the sharp likelihood estimation unit 17. th is a threshold.

In [Math. 1], (2-1) indicates that “the output of the sharp likelihood estimation unit 17 is selectively used for the data estimated not to be actual data (the output is used as the corrected likelihood).” (2-2) indicates that “the output of the class likelihood estimation unit 13 is selectively used with respect to the estimated actual data (the output is used as the corrected likelihood).”

By adding the sharp likelihood estimation unit 17 and the class likelihood correction unit 18, the estimation accuracy by the cause estimation unit 16 is expected to be improved. That is, a case where the unknown degree is higher than the threshold α and the label noise degree is higher than the threshold β is considered logically, but it is expected that such a case will be eliminated by the sharp likelihood estimation unit 17 and the class likelihood correction unit 18.

In the second embodiment, the class label estimation unit 14 and the label noise degree estimation unit 15 are different from the first embodiment in that the output from the class likelihood correction unit 18 is input instead of the output from the class likelihood estimation unit 13.

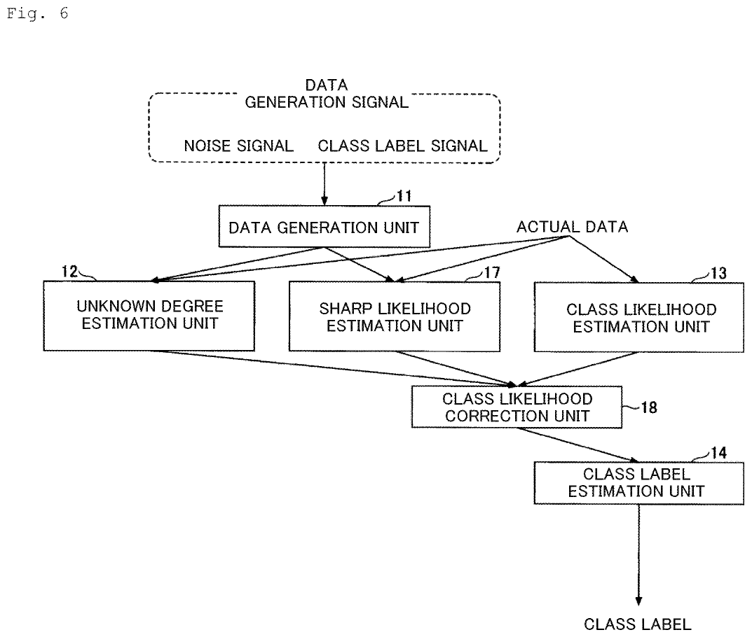

FIG. 6 is a diagram for describing a functional configuration example for the case of learning of the class label estimation apparatus 10a according to the second embodiment. In FIG. 6 the same parts as those in FIG. 5 are designated by the same reference numerals. Among the respective units shown in FIG. 6, the data generation unit 11, the unknown degree estimation unit 12, the sharp likelihood estimation unit 17 and the class likelihood estimation unit 13 are neural networks to be trained. On the other hand, the class likelihood correction unit 18 and the class label estimation unit 14 are algorithms used for learning of the data generation unit 11 at the time of learning.

The data generation unit 11 performs learning so that the unknown degree is estimated to be low by the unknown degree estimation unit 12 and the same label as the class label signal is estimated by the class label estimation unit 14, similarly to the conventional ACGAN.

The unknown degree estimation unit 12 performs learning so that it can discriminate whether the input data is the output of the data generation unit 11 or the actual data, similarly to the conventional ACGAN.

The sharp likelihood estimation unit 17 uses the generated data and the actual data in the training set as inputs and performs learning so that the likelihood of the label of the input data becomes relatively high. For example, the sharp likelihood estimation unit 17 performs learning so that the likelihood is overwhelmingly high, such as the likelihood of the correct answer class=99%. The label of the input data is a label indicated by the class label signal when the input data is generated data, and is a label given to the actual data in the training set when the input data is the actual data in the training set.

The class likelihood estimation unit 13 performs learning so that the likelihood of a label given to actual data being input data becomes relatively high. At the time of learning, no generated data is input to the class likelihood estimation unit 13.

The class likelihood correction unit 18 corrects the likelihood of each label estimated by the class likelihood estimation unit 13 on the basis of the unknown degree estimated by the unknown degree estimation unit 12 and the likelihood of each label estimated by the sharp likelihood estimation unit 17.

The class label estimation unit 14 estimates the label of the input data on the basis of the likelihood of each label corrected by the class likelihood correction unit 18. The estimation result is used for learning of the data generation unit 11.

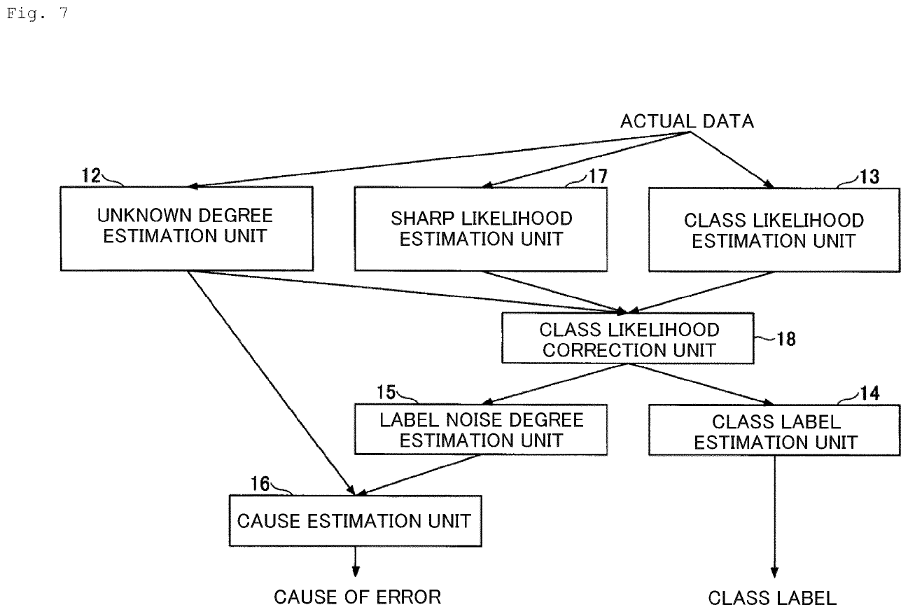

FIG. 7 is a diagram for describing a functional configuration example for the case of inference of the class label estimation apparatus 10a in the second embodiment. In FIG. 7, the same parts as those in FIG. 5 are designated by the same reference numerals. As shown in FIG. 7, the data generation unit 11 is not used at the time of inference. Further, the actual data at the time of inference is data to be estimated on the label (for example, data used in actual operation), to which no label is attached.

The processing of each unit at the time of inference is as described above. That is, the unknown degree estimation unit 12 estimates the unknown degree of the actual data. Each of the sharp likelihood estimation unit 17 and the class likelihood estimation unit 13 estimates the likelihood of each label for the actual data. The class likelihood correction unit 18 corrects the softmax vector which is an estimation result from the class likelihood estimation unit 13 on the basis of the unknown degree estimated by the unknown degree estimation unit 12 and the estimation result from the sharp likelihood estimation unit 17. The class label estimation unit 14 estimates the label of the actual data on the basis of the corrected likelihood of each label. The label noise degree estimation unit 15 estimates the label noise degree on the basis of the corrected likelihood of each label. The cause estimation unit 16 estimates the cause of the error (unknown, label noise, or no problem) by threshold processing for the unknown degree and the label noise degree.

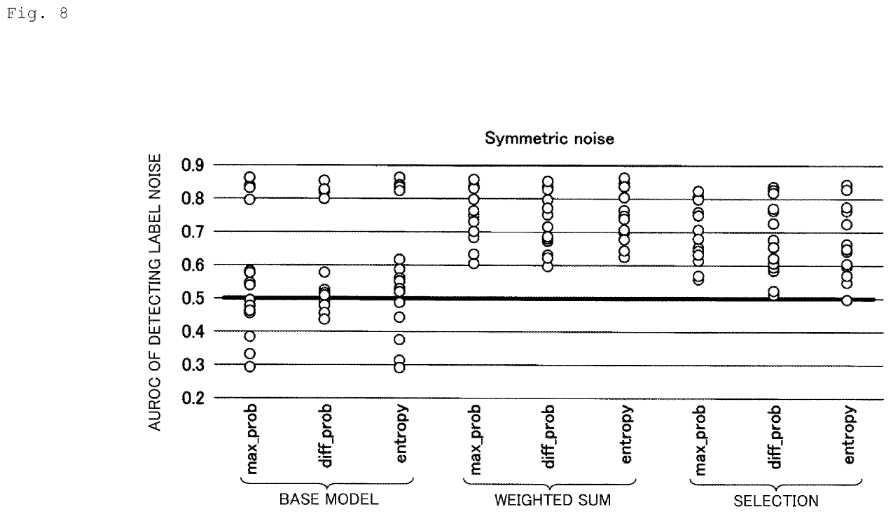

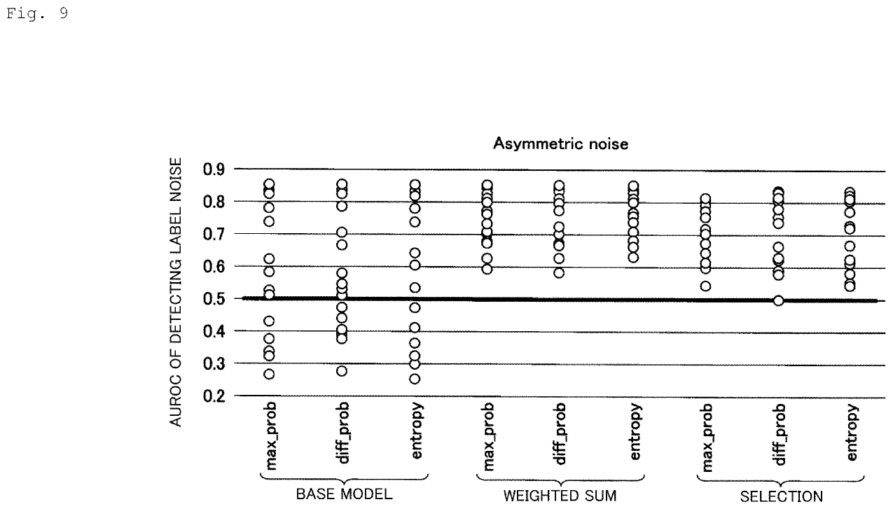

FIGS. 8 and 9 are diagrams for describing performance of detecting label noise according to the second embodiment. The views of FIGS. 8 and 9 are the same as those of FIG. 4. Here, in the horizontal axis of FIGS. 8 and 9, the “base model” corresponds to the configuration of the first embodiment. The “weighted sum” and the “selection” correspond to the second embodiment. The “weighted sum” corresponds to a case where correction by the class likelihood correction unit 18 is performed by the weighted sum by the unknown degree. The “selection” corresponds to a case in which correction by the class likelihood correction unit 18 is performed by selection of any one likelihood based on the unknown degree.

Note that the type of label noise is different between FIGS. 8 and 9. FIG. 8 corresponds to the case where the label noise is “Symmetric noise,” and FIG. 9 corresponds to the case where the label noise is “Asymmetric noise.” “Symmetric noise” means label noise that mistakes with equal probability for each of labels prepared for data. For example, when there are four classes of “dog, cat, rabbit, and monkey,” label noise such as a dog being mistaken with equal probability to three classes other than the dog, a cat being mistaken with equal probability to three classes other than the cat, and so on is “Symmetric noise.” On the other hand, “Asymmetric noise” refers to label noise in which the probability of error is not equal probability, unlike “Symmetric noise.” For example, when there are four classes of “dog, cat, rabbit, and monkey,” the label noise that mistakes a dog for a cat but not a rabbit or a monkey is “Asymmetric noise.”

In both FIGS. 8 and 9, according to the second embodiment, it can be seen that the number of datasets having the performance (AUROC) of detecting the label noise of the chance rate (=0.5) or less has decreased. Therefore, it is considered that it was verified that the performance of detecting label noise was improved by the second embodiment.

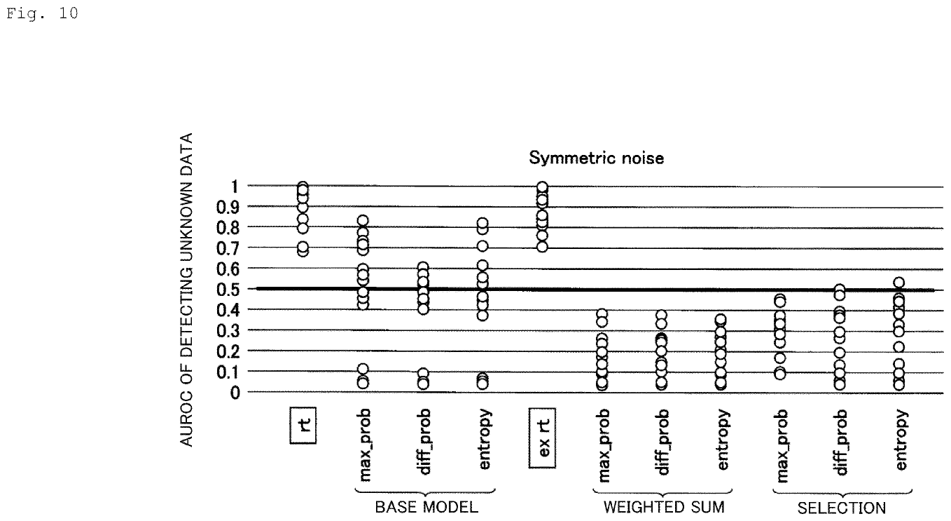

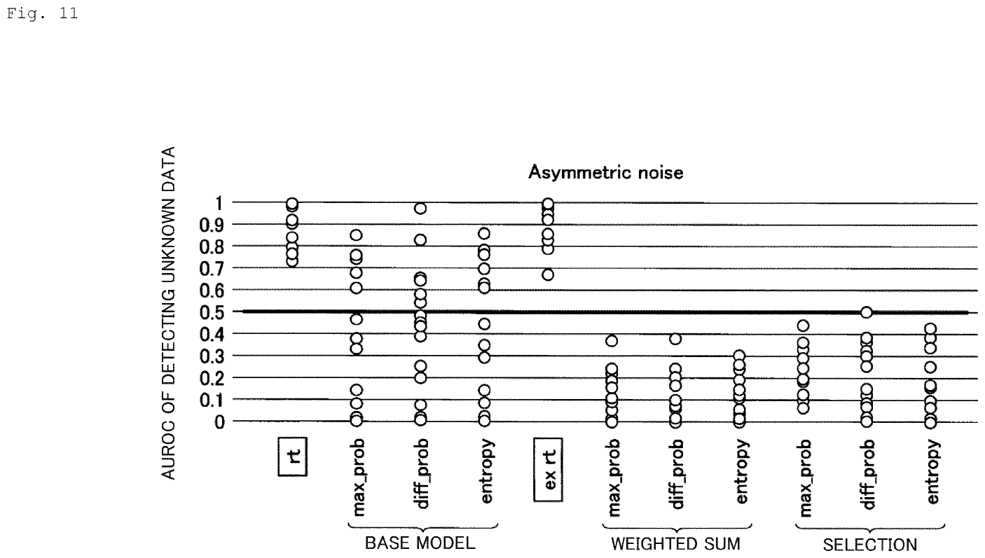

FIGS. 10 and 11 are diagrams for describing the performance of detecting unknown data according to the second embodiment. The vertical axis in FIGS. 10 and 11 represents the performance (AUROC) of detecting unknown data. Further, “rf” on the horizontal axis corresponds to the detection performance based on the unknown degree by the base model, and “ex rf” corresponds to the detection performance based on the unknown degree according to the second embodiment. Further, the relationship between FIGS. 10 and 11 is the same as that between FIGS. 8 and 9. The other horizontal axes correspond to the performance of detecting unknown data based on the label noise degree.

In the second embodiment, since the unknown degree and the label noise degree are evaluated independently of each other, there is no guarantee that the label noise degree is lowered in the unknown data, but according to FIGS. 10 and 11, it can be seen that in the second embodiment, the performance of detecting unknown data based on the label noise degree is low. That is, since the label noise no longer responds to the unknown data, it can be expected that there is a low possibility that the unknown data and the label noise are simultaneously estimated as the cause of the error in the error detection result. In other words, it can be expected that the error detected on the basis of the label noise degree is guaranteed to be label noise (not unknown data).

The performance of detecting the unknown data is similar to that of the “rf” column and the “ex rf” column. This indicates that there is almost no adverse effect due to the change of the likelihood estimation method for each label with respect to the detection of unknown data at the unknown degree.

As described above, according to the second embodiment, it is possible to automatically estimate the cause of an error by the deep model while executing the task (label estimation). In addition, it is possible to secure the validity of the model as an evaluation value of label noise. Further, it is possible to prevent the flatness of the softmax, which is an evaluation value of label noise, from reacting with unknown data (avoid making the softmax vector flat with respect to unknown data), and improve the performance of estimating errors due to label noise.

In the second embodiment, the class label estimation apparatus 10a is an example of a learning apparatus and the class label estimation apparatus 10. The class likelihood estimation unit 13 is an example of a first class likelihood estimation unit. The sharp likelihood estimation unit 17 is an example of a second class likelihood estimation unit.

Although the embodiments of the present invention have been described in detail above, the present invention is not limited to these particular embodiments, and various modifications and changes are possible within the scope of the gist of the present invention described in the claims.

### REFERENCE SIGNS LIST

10, 10a Class label estimation apparatus
11 Data generation unit
12 Unknown degree estimation unit
13 Class likelihood estimation unit
14 Class label estimation unit
15 Label noise degree estimation unit
16 Cause estimation unit
17 Sharp likelihood estimation unit
18 Class likelihood correction unit
100 Drive device
101 Recording medium
102 Auxiliary storage device
103 Memory device
104 Processor
105 Interface device
B Bus

1. A learning apparatus comprising:
a processor; and
a memory that includes instructions, which when executed, cause the processor to execute:
learning generation of data based on a class label signal and a noise signal;
learning estimation of an unknown degree indicating a degree to which input data is unknown using a training set and the data generated at the learning the generation of the data;
learning estimation of a first likelihood of each class label for input data using the training set;
learning estimation of a second likelihood of each class label for input data using the training set and the data generated at the learning the generation of the data;
generating a third likelihood by correcting the first likelihood on the basis of the unknown degree and the second likelihood; and
estimating a class label of data related to the third likelihood on the basis of the third likelihood,
wherein the learning the generation of the data includes learning the generation on the basis of the unknown degree and the class label estimated at the estimating.

2. The learning apparatus according to claim 1, wherein the learning the estimation of the second likelihood includes learning estimation of the second likelihood of each class label so that the second likelihood of the class label indicated by the class label signal or the class label given to the training set is relatively high.

3. The learning apparatus according to claim 1, wherein the generating of the third likelihood includes generating a weighted sum of the first likelihood and the second likelihood, or the first likelihood or the second likelihood as the third likelihood.

4. An estimation apparatus comprising:
a processor; and
a memory that includes instructions, which when executed, cause the processor to execute:
estimating an unknown degree indicating a degree to which input data is unknown;
estimating a first likelihood of each class label for the input data on the basis of learning using a training set;
estimating a second likelihood of each class label for the input data on the basis of data generated on the basis of a class label signal and a noise signal and the learning using the training set;
generating a third likelihood by correcting the first likelihood on the basis of the unknown degree and the second likelihood;
estimating a degree of label noise in the training set on the basis of the third likelihood; and
estimating a cause of an error related to the input data on the basis of the unknown degree and the degree of label noise.

5. A learning method executed by a computer, the learning method comprising:
learning generation of data based on a class label signal and a noise signal;
learning estimation of an unknown degree indicating a degree to which input data is unknown using the data generated at the learning the generation of the data and a training set;
learning estimation of a first likelihood of each class label for input data using the training set;
learning estimation of a second likelihood of each class label for input data using the data generated at the learning the generation of the data and the training set;
generating a third likelihood by correcting the first likelihood on the basis of the unknown degree and the second likelihood; and
estimating a class label of data related to the third likelihood on the basis of the third likelihood,
wherein, at the learning the generation of the data, the generation is learned on the basis of the unknown degree and the class label estimated at the estimating of the class label.

6. (canceled)

7. A non-transitory computer-readable recording medium storing a program that causes a computer to function as the learning apparatus according to claim 1.

8. A non-transitory computer-readable recording medium storing a program that causes a computer to function as the estimation apparatus according to claim 4.
